(19) United States
(12) Patent Application Publication
(10) Pub. No.: US 2005/0154530 A1
(43) Pub. Date: Jul. 14, 2005

(54) Colliding obstacle detection apparatus for vehicle

(75) Inventors: Toshio Hosokawa, Anjo-city (JP); Tetsuya Takafuji, Anjo-city (JP); Yoshiyuki Hattori, Toyoake-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/007,303

(22) Filed: Dec. 9, 2004

(30) Foreign Application Priority Data
Jan. 8, 2004 (JP) 2004-3191
Aug. 6, 2004 (JP) 2004-230928

(51) Int. Cl. G06F 17/00

(52) U.S. Cl. 701/301; 340/436

(57) ABSTRACT

The present colliding obstacle detection apparatus comprises a pedestrian bumper, which is supported below a front bumper of the vehicle by a body of the vehicle, at least one collision detector, which is located on the pedestrian bumper, and a control circuit, which determines whether the collision has actually occurred based on a detection signal outputted by the at least one collision detector. The front end of the pedestrian bumper vertically aligns with or extending ahead of that of the front bumper. The at least one collision detector detects one of a collision of the pedestrian bumper with an obstacle, and a presence of the obstacle in a close proximity to the pedestrian bumper. When the control circuit determines that the collision has actually occurred, the circuit activates a colliding obstacle protector for protecting the obstacle, especially a pedestrian.

### CROSS REFERENCE TO RELATED APPLICATION

This application is based upon and claims the benefit of priority of Japanese Patent Applications No. 2004-003191 filed on Jan. 8, 2004 and No. 2004-230928 filed on Aug. 6, 2004, the content of which is incorporated herein by reference.

### FIELD OF THE INVENTION

The present invention relates to a colliding obstacle detection apparatus for a vehicle, which is especially suitable for protecting a pedestrian colliding with the vehicle.

### BACKGROUND OF THE INVENTION

A collision detector, which detects a colliding obstacle such as a pedestrian, is conventionally used for activating a colliding obstacle protector such as a colliding pedestrian protector located on a vehicle. A usage of an output signal outputted from the collision detector prevents the colliding obstacle protector from erroneous operation. In a case that the collision detector has a function to identify pedestrians among the colliding obstacles, the pedestrian protector does not operate in vain for the colliding obstacles other than pedestrians.

A colliding load sensor or a capacitance sensor conventionally implements the above collision detector. To detect pedestrians, these sensors are conventionally located on a front face of a front bumper so as to detect proximity of a colliding obstacle by a fluctuation of a colliding load or a grounded capacitance in front of the vehicle. For example, JP2000-326808A discloses to detect a collision occurrence and to identify a classification of the colliding obstacle by the fluctuation of the capacitance. JP11-028994A discloses to detect a collision occurrence and to identify the classification of the colliding obstacle by using a load sensor (also called as “colliding load sensor”) detecting impact acting on the vehicle body at the collision.

A hood-lifting mechanism or a pedestrian airbag conventionally implements the above colliding pedestrian protector. JP2001-39242A discloses to comprise below the front bumper a pedestrian bumper extendable ahead of the front bumper so as to make the colliding pedestrian fall onto the hood of the vehicle.

However, some experiments raised the following issues in the above conventional collision detectors for protecting colliding pedestrian.

First, in the above conventional example comprising on the front face of the front bumper the colliding load sensor implemented by a pressure sensor, the rigidity of a bumper cover and a bumper absorber constituting the element of the front bumper mechanism is small, and the uniformity of the rigidity thereof is also small. Thus, the colliding load generated by the colliding pedestrian varies within the side-to-side direction thereof, causing difficulty in distinguishing whether the colliding obstacle is a pedestrian or other obstacles. To decrease the variety of the colliding load within the front bumper at the pedestrian collision, it is necessary to increase the rigidity and the uniformity of the front bumper. However, this is difficult because the rigidity of the front bumper is set mainly to absorb the colliding impact.

Second, in the above conventional example comprising on the front face of the front bumper the capacitance sensor, which has a plate electrode of a grounded capacitor vertically arranged on the front face of the front bumper, to detect the grounded capacitance in front of the vehicle (hereinafter referred to as “front grounded capacitance”). The electrode has a large area and arranged close to the body of the vehicle, so as to make an issue that the grounded capacitance against the body of the vehicle (hereinafter referred to as “rear grounded capacitance”) also becomes quite large. The rear and the front grounded capacitances are arranged in parallel to each other in an equivalent circuit of the capacitance sensor. Thus, even when the front grounded capacitance fluctuates by a colliding or proximate obstacle, the potential fluctuation in the electrode is small, because the rear grounded capacitance is large. This causes an issue to decrease a pedestrian-detecting sensitivity by a proximate pedestrian, and to make it hard to identify the pedestrian with high accuracy.

Third, it is necessary to accomplish as fast as possible to detect a collision and to identify the classification of the colliding obstacle, to spare a mechanical operating time from the collision detection to an accomplishment of operating the colliding obstacle detector. However, the colliding load sensor does not start the operation thereof until a colliding obstacle collides with the front bumper. The capacitance sensor also cannot identify a colliding obstacle until a colliding obstacle comes quite close to the front bumper because of the above issue of the detection accuracy. Thus, the time is very limited for operating the colliding obstacle protector, so that it becomes necessary to operate the colliding obstacle protector fast. This increases a mechanical complexity and the manufacturing cost of the colliding obstacle protector.

Further, the difference between the grounded capacitances of the pedestrian (or, a human body) and the metallic obstacle is small, and the output gradient of the sensor when detecting the former is in same directions as that when detecting the latter. These cause an issue of making it difficult to identify a human body from some shape and/or kind of metallic obstacles. At the same time, these conventional examples detect a collision erroneously even when a human body just touches or passing nearby the front bumper not colliding thereto.

Furthermore, it is hard for the colliding load sensor to identify from a human body the colliding obstacle having a mass, rigidity or a frictional coefficient to road surface close to those of the human body, such as a signboard and a fence having weight close to that of human body.

### SUMMARY OF THE INVENTION

An object of the present invention is to provide a colliding obstacle detection apparatus for a vehicle, which can detect accurately and rapidly a collision with a forward obstacle, especially with a forward pedestrian.

To achieve the above object, a colliding obstacle detection apparatus according to the present invention comprises a pedestrian bumper supported below a front bumper of the vehicle by a body of the vehicle. The front end of the pedestrian bumper vertically aligns with or extending ahead of that of the front bumper.

The colliding obstacle detection apparatus further comprises at least one collision detector located on the pedestrian bumper. The at least one collision detector detects one of a collision of the pedestrian bumper with an obstacle, and a presence of the obstacle in a close proximity to the pedestrian bumper. The colliding obstacle detection apparatus further comprises a control circuit determining whether the collision has actually occurred based on a detection signal outputted by the at least one collision detector. When the control circuit determines that the collision has actually occurred, the circuit activates a colliding obstacle protector for protecting the obstacle, especially a pedestrian.

### BRIEF DESCRIPTION OF THE DRAWINGS

Other features and advantages of the present invention will be appreciated, as well as methods of operation and the function of the related parts, from a study of the following detailed description, the appended claims, and the drawings, all of which form a part of this application. In the drawings:

FIG. 1 is a block diagram of a colliding obstacle detection apparatus for vehicle according to the first embodiment;

FIG. 2 is a circuit diagram of a coil impedance sensor;

FIG. 3 is a circuit diagram of a capacitance sensor;

FIG. 4 is a circuit diagram of the impedance sensor detecting coil impedance and capacitance;

FIG. 5 is a circuit diagram of a modified impedance sensor incorporating a differential amplifier into that shown in FIG. 4;

FIG. 6 is a schematic diagram of the arrangement of a coil and an electrode in the impedance sensor shown in FIG. 4;

FIG. 7 is a schematic sectional view showing the arrangement of the impedance sensor shown in FIG. 1 and the piezoelectric sensor;

FIG. 8 is a schematic front view showing the arrangement of the sensors shown in FIG. 7;

FIG. 9 is a schematic top view showing a colliding obstacle detection apparatus according to the first embodiment;

FIG. 10 is a schematic side view of the colliding obstacle detection apparatus shown in FIG. 9;

FIG. 11 is a schematic top view showing a colliding obstacle detection apparatus according to the second embodiment;

FIG. 12 is a schematic side view of the colliding obstacle detection apparatus shown in FIG. 11;

FIG. 13 is a schematic top view of the colliding obstacle detection apparatus shown in FIG. 11, whose pedestrian bumper retracting;

FIG. 14 is a schematic side view of the colliding obstacle detection apparatus shown in FIG. 13; and

FIG. 15 is a schematic side view of a colliding obstacle detection apparatus according to the third embodiment.

### DESCRIPTION OF THE PREFERRED EMBODIMENTS

### First Embodiment

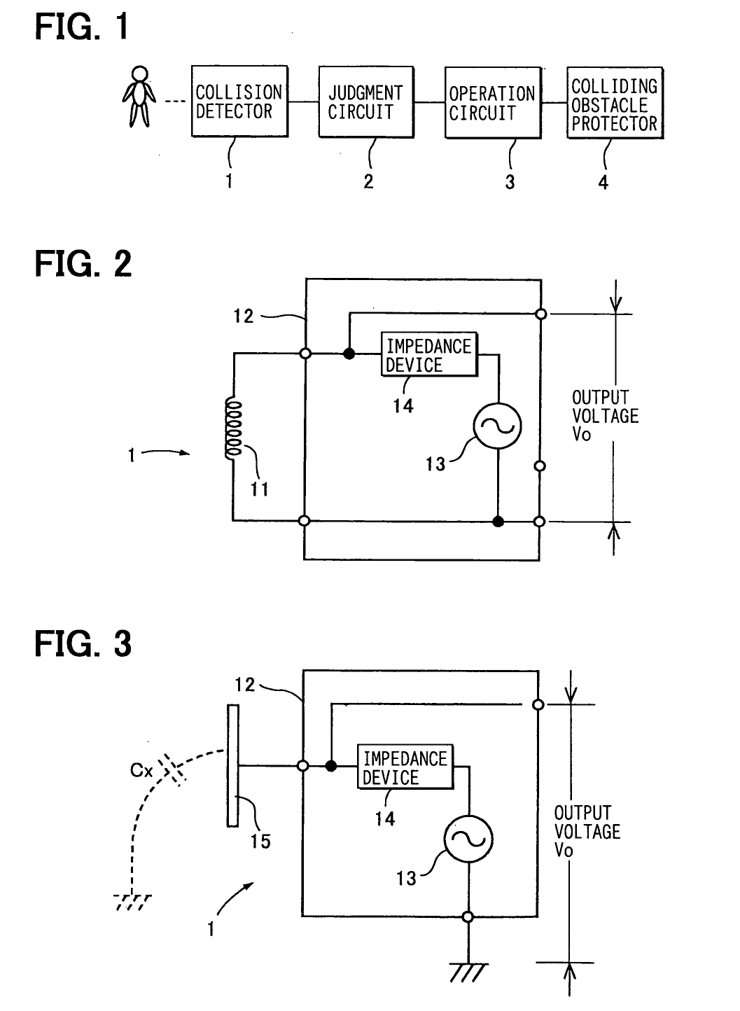

FIG. 1 depicts a block diagram of a colliding obstacle detection apparatus of this embodiment. Collision detector 1 detects an obstacle colliding with the pedestrian bumper described later. A judgment circuit 2 determines whether a collision has occurred and classifies the colliding obstacle based on the output voltage sent by the collision detector 1. In a case that the judgment circuit 2 determines a collision has occurred and classifies the colliding obstacle is a pedestrian, the judgment circuit 2 outputs a signal. An operation circuit 3 receives the signal and operates a colliding obstacle protector 4. The operation circuit 3 inhibits the colliding obstacle protector 4 from operating without receiving the signal. The judgment circuit 2 and the operation circuit 3 compose the control circuit of the present invention.

FIG. 2 depicts an example of the collision detector 1. A coil 11 is located on a bumper plate of a pedestrian bumper. An electricity supply circuit 12 supplies alternate current to the coil 11. The electricity supply circuit 12 comprises an AC power supply unit 13 and an impedance device 14. The AC power supply unit 13 supplies an alternate current of a predetermined frequency (desirably from 50 kHz to 500 kHz) via the impedance device 14 to the coil 11.

Thus, when a metallic body comes close to the coil 11 so that eddy currents flows therein, the impedance of the coil 11 decreases and a voltage drop therein is also decreases. The voltage between both ends of the coil 11 can be used an output voltage Vₒ. A resistor can implement the impedance device 14, for example. It is desirable that the electricity supply circuit 12 is a constant current supply circuit so that the output voltage Vₒ is proportionate to the impedance of the coil 11.

The judgment circuit 2 rectifies the output voltage Vₒ, compares that with a threshold voltage Vₜₕ and outputs the result. In the case that the judgment circuit 2 determines the output voltage Vₒ is smaller than the threshold voltage Vₜₕ, the operation circuit 3 inhibits commonly-known pedestrian protectors from operation such as an airbag located on the hood and a hood-lift mechanism. This is because the judgment circuit 2 has determined that the obstacle is a metallic one, not a pedestrian. The pedestrian does not make the impedance of the coil 11 decrease so much, so that the judgment circuit 2 can identify pedestrians from metallic obstacles with high accuracy.

It is desirable that the pedestrian bumper comprises another collision detector 1 detecting collision with or proximity to obstacles including pedestrians, which a colliding load sensor and/or an ultrasonic sensor can implement. The colliding load sensor is, for example, a sheet-shaped pressure sensor affixed on the front face of the bumper plate and detecting a colliding load. The ultrasonic sensor irradiates an ultrasonic wave ahead of the bumper plate and receives the reflected wave, and detects a presence of and a distance to an obstacle in front of and close to the bumper plate based on an intensity of the reflected wave and a time from the irradiation to the reception.

A piezoelectric plastic film is suitable for these sheet-shaped pressure sensor or ultrasonic sensor with a pair of electrodes at both surfaces thereof, whose thickness increases and decreases according to the voltage applied thereto, and which generates voltages according to the pressure applied thereto.

A capacitance sensor shown in FIG. 3 can implement an alternative of the collision detector 1 shown in FIG. 2, or above another collision detector 1 detecting colliding obstacles including pedestrians.

In FIG. 3, an electrode 15 is affixed on the front face of the bumper plate of the pedestrian bumper, and constitutes an electrode of the grounded capacitor. Power supply circuit 12 supplies alternate current to the electrode 15. The power supply circuit 12 comprises an AC power supply 13 and an impedance device 14. The AC power supply 13 supplies an alternate current of a predetermined frequency (desirably from 50 to 500 kHz) via an impedance device 14 to the plate electrode 15.

Thus, when a conductor (a metallic obstacle or a human body) comes close to the plate electrode 15 being in equivalent contact with ground, the capacitance between the conductor and the electrode 15 increases and the voltage drop thereof decreases, which can be set as the output voltage Vₒ. A resistor implements the impedance device 14, for example . A constant current supply circuit is suitable for the power supply circuit 12, which can output an output voltage Vₒ generally inversely proportional to the grounded capacitance of the electrode 15.

The judgment circuit 2 rectifies the output current Vₒ, compares that with a threshold voltage level Vₜₕ and outputs the result. In the case that the judgment circuit 2 determines the output voltage Vₒ is smaller than the threshold voltage Vₜₕ, the operation circuit 3 activates commonly-known pedestrian protectors such as an airbag installed on the hood and a hood-lift mechanism. This is because the colliding obstacle is determined to be a human body (including a metallic obstacle having generally a same size as that of human body).

By comprising both of the sensors shown in FIGS. 2 and 3 on the bumper plate of the pedestrian bumper, it becomes possible to detect a pedestrian and the metallic material generally as big as pedestrian, and to distinguish between the former and the latter. Thus, these output voltages makes it possible to activate the pedestrian protector 4 only when a pedestrian comes close to or collides with the front bumper.

The sensors shown in FIGS. 1 and 2 naturally do not detect electric-insulating obstacles and do not activate the pedestrian protector 4 for the electric-insulating obstacles. It is also naturally able for the sensors to activate protectors other than the pedestrian protector 4, such as occupant protectors when they detect that an obstacle colliding with and/or close to the bumper plate of the pedestrian bumper. That is, the colliding impact absorbing operation can be planed by detecting at an early timing the vehicular collision or a collision with static structure.

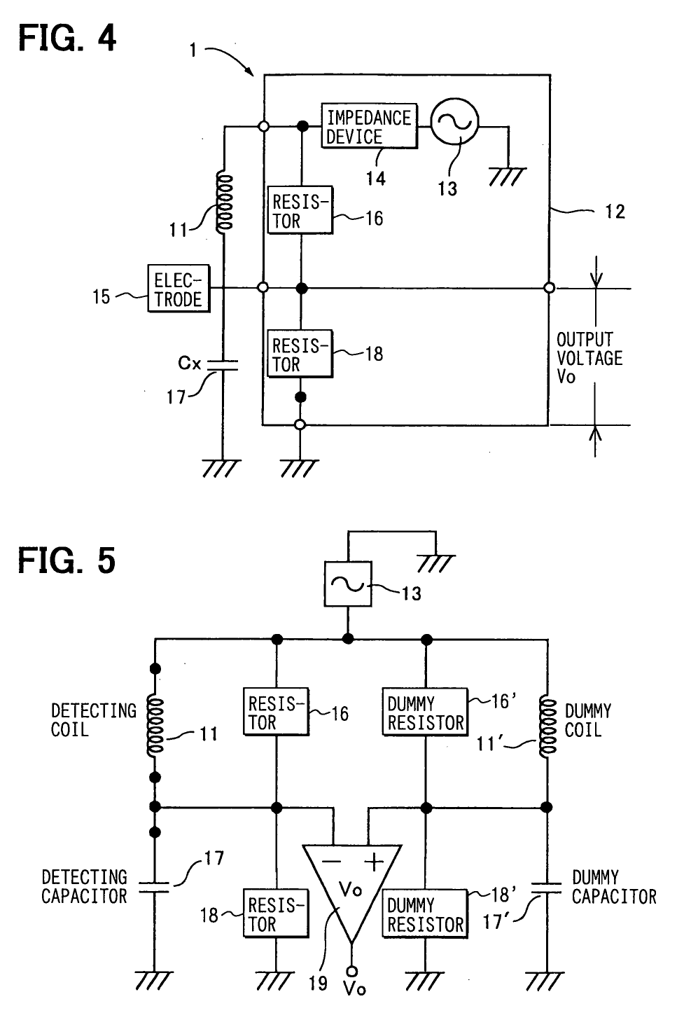

FIG. 4 depicts an example in which the coil sensor shown in FIG. 2 and the electric capacity sensor shown in FIG. 3 are combined.

An AC power supply 13 applies an electrode 15 an alternate voltage via an impedance device 14 and a coil 11. A resistor 16 is arranged in parallel with the coil 11, and a resistor 18 is arranged in parallel with the capacitor 17 which are grounded. The capacitor 17 has a grounded capacitance Cₓ in the electrode 15. A bumper plate of the pedestrian bumper described later comprises the coil 11 and the electrode 15. The resistors 16 and 17, which are for adjusting the output voltage Vₒ, are not always necessary.

Thus, as described above, the output voltage Vₒ increases when a metallic obstacle comes close and decreases when a pedestrian comes close. Accordingly, substantially one sensor can rapidly detect that a pedestrian or a metallic obstacle comes close and distinguish between the proximate pedestrian and metallic obstacle.

FIG. 5 depicts a modified example from that shown in FIG. 4.

This example incorporates a dummy coil 11′, a dummy capacitor 17′, dummy resistors 16′ and 18′ and a differential amplifier 19 into the impedance sensor shown in FIG. 4. When no colliding obstacle exists, the impedance of the dummy coil 11′ equals that of the detector coil 11, the capacitance to ground of the dummy capacitor 17′ equals that of the detector capacitor 17, the resistance of the dummy resistor 16′ equals that of the resistor 16, and the resistance of the dummy resistor 18′ equals that of the resistor 18.

It is desirable to set the impedances of the dummy coil 11′ and of the dummy capacitor 17′ in consideration of the inductance and the eddy current (constituent of the resistance) of the detector coil 11 much influenced by the vehicle body located just behind the pedestrian bumper because the magnetic flux generated by the coil 11 comes in linkage with and flows therein, and the grounded capacitance of the electrode 15 enlarged by the vehicle body which is a grounded metallic body. The advantage of this circuit is in the compensation of impedance fluctuation caused by the exothermic dummy coil 11′.

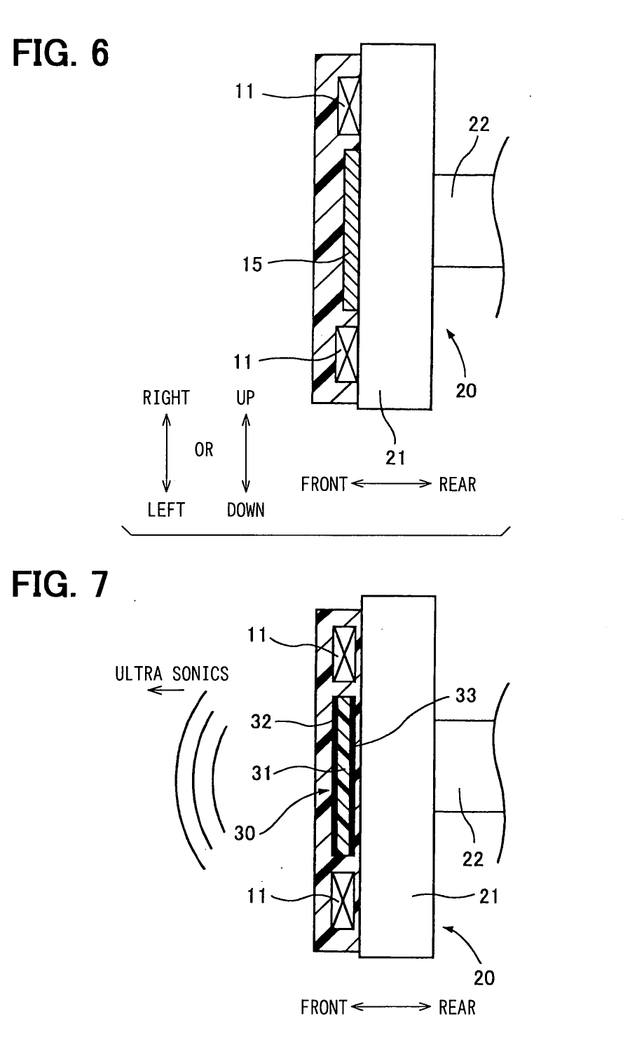

FIG. 6 depicts another example arranging the electrode 15 of the detecting capacitor 17 inside of the coil 11. FIG. 6 shows a pedestrian bumper 20, a bumper plate 21 thereof and rods 22 supporting the bumper plate 21. The electrode 15 arranged within the coil 11 can extend in large area on the front face of the bumper plate 21. The electrode 15 has a shape of a comb or a coil whose one end is open, to reduce the eddy current in the electrode 15 generated by the magnetic flux of the coil 11.

FIG. 7 depicts another example comprising a sheet-shaped sensor 30, which is a colliding load sensor or an ultrasonic sensor.

The sensor 30 located on the pedestrian bumper 20 comprises a piezoelectric plastic film 31 affixed on the front face of the bumper plate 21 and a pair of electrode layers 32 and 33 laminated on the both sides thereof. The bumper plate 21 can replace one of the electrode layers 33 affixed on the bumper plate side if the bumper plate is metallic one. The collision detector shown in FIG. 7 has a plastic bumper plate 21 and both of a pair of the elect rode layers 32 and 33 to reduce the vehicle weight and the generation of parasitic eddy current in the coil 11 and the parasitic capacitance of the electrode 15, that is, a rear impedance.

The piezoelectric plastic film 31 expands and shrinks to emit ultrasonic waves in front of the vehicle by applying alternate voltage between the electrode layers 32 and 33 of the sensor 30. This is substantially based on the same principle as conventional film speaker. When an obstacle is present in front of the vehicle, the obstacle reflects the emitted ultrasonic wave, and the reflected ultrasonic wave makes the piezoelectric plastic film 31 expands and shrinks, so as to generate a voltage having a frequency of the ultrasonic wave between the electrode layers 32 and 33. The intensity of the reflected ultrasonic wave forms a signal voltage according thereto, by extracting the band of the frequency in the ultrasonic wave, and rectifying and integrating the extracted ultrasonic wave.

In addition to detecting the presence of the colliding obstacle by the intensity of the reflected ultrasonic wave, the distance to the obstacle may be measured by the time between the emission and the reception of the ultrasonic wave. As conventionally known, a ultrasonic wave emitter and a pair of ultrasonic wave receptors can be detect the distance to the colliding obstacle and the position in a side-to-side direction thereof by using triangulation techniques. A ceramic piezoelectric device or a magnetostrictive device may be used instead of the piezoelectric plastic film 31.

Only the ultrasonic sensor cannot distinguish between pedestrian and other colliding obstacle. A combined use of the ultrasonic sensor and the sensors shown in FIGS. 2 and 3 identifies each of the electric insulating obstacle, metallic obstacle and human body, and makes safer provisions against collisions.

It merits attention that the piezoelectric sensor 30 detects a collision occurrence and takes readings of a waveform of a colliding load. The load detection sensor also serves as the above ultrasonic sensor 30 by imposing the load detection sensor an alternate voltage. The AC power supplying current to the impedance sensor shown in FIGS. 2 to 4 can also supply current to the ultrasonic sensor.

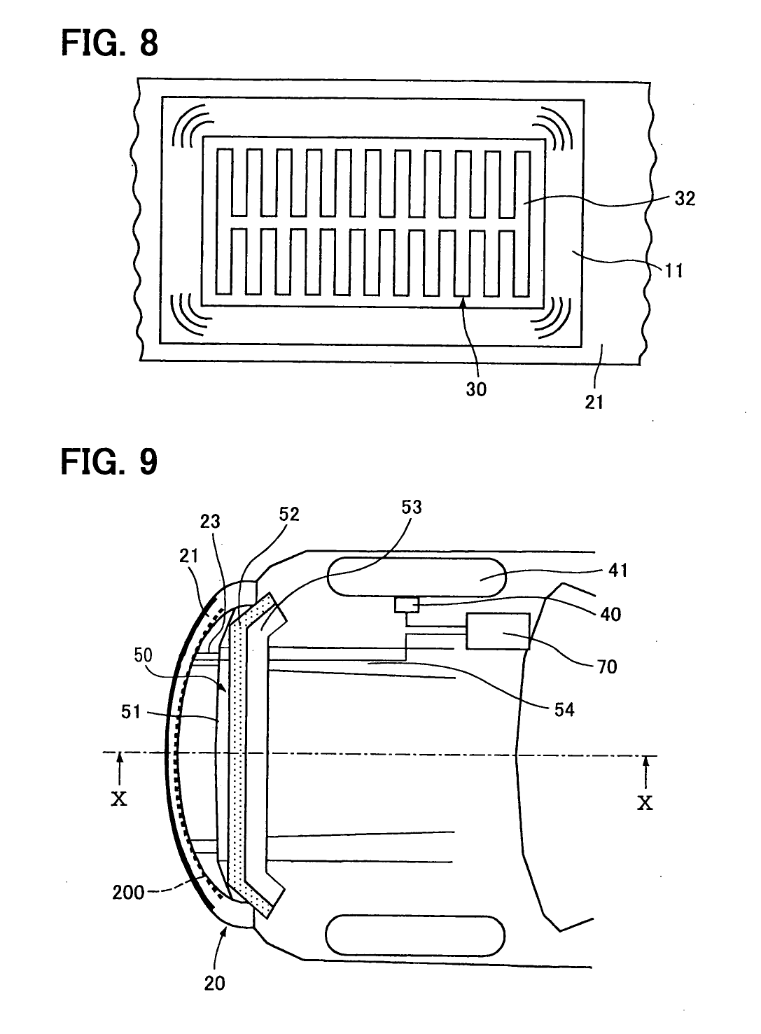

FIG. 8 depicts an example of collision obstacle detection apparatus in which the sensor 30 and the impedance sensor 1 shown in FIG. 4 are affixed on the front face of the bumper plate 21. The coil 11 surrounds the sensor 30. The sensor 30 has a form of comb tooth for reducing the eddy current generated by the electrode layers 32 and 33, however they may have a form of a coil whose one end is open.

The electrode layer 32 of the sensor 30 may do double duty of itself and the electrode plate 15 shown in FIG. 4. The sensor 30 may be imposed an alternate current for lasing ultrasonic wave via the coil 11 from the AC power supply 4. The collision detector may be plural and arranged side-to-side on the bumper plate 21 of the pedestrian bumper 20. Thus, the collision detector can detect the position of the collision in the side-to-side direction. The piezoelectric film 31 may be formed to have small area for serving as the above ultrasonic sensor.

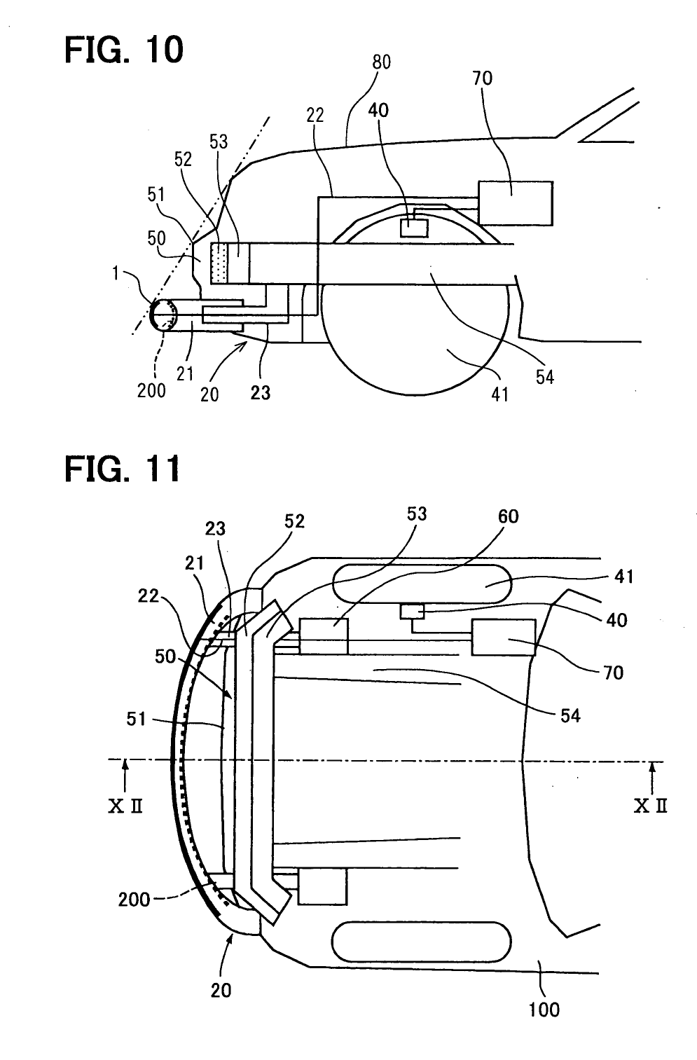

The pedestrian bumper 20 implemented by an unextendable pedestrian bumper is described referring to FIGS. 9 and 10.

On the front face of the vehicle body 100 is located a front bumper 50 comprising a bumper cover 51 and a bumper absorber 53 surrounded by the bumper cover 51. The bumper absorber 52 is located on a front face of the bumper reinforcement 53. The bumper reinforcement 53 is affixed on front ends of the side members 54.

Below the front bumper 50, as shown in FIG. 10, is located a pedestrian bumper 20 implemented by an unextendable pedestrian bumper. The pedestrian bumper 20 comprises a pair of stays (support mechanism) 23 fixed to the side members 54 and protruding forward, and a plastic bumper plate 21 fixed to the front ends of a pair of the stays 23 and extending in a side-to-side direction. A wiring 22 connects the sensors 1, 200 and the control unit 70.

On the front face of the bumper plate 32 is located a impedance sensor 1 shown in FIG. 4, and on the rear face of the bumper plate 21 is located a colliding load sensor 200, respectively to extend in the side-to-side direction. The impedance sensor 1 is already described, and the colliding load sensor 200 is further described in the following.

The colliding load sensor 200 detects the fluctuation of the resistance according to the stress applied onto the film colliding load sensor 200 by the deformation of the bumper plate 21 at a collision. Common piezoelectric materials, whose resistance changes according to the stress applied thereto, can implement the colliding load sensor 200. The collision detection sensor 200 may be located on the front face of the bumper plate 21. A pressure sensor described in the first embodiment may implement the colliding load sensor 200.

The control unit 70 determines whether a pedestrian collides with the vehicle in traveling within a predetermined velocity detected by a velocity sensor 40 detecting the rotational frequency of the wheel 41, and controls the operation of the pedestrian protector based on the result of the decision. The control unit 700 inhibits the pedestrian protector from operation when the vehicle velocity is not within the predetermined range.

The front ends of the hood 80, the front bumper 50 and the bumper plate 21 of pedestrian bumper 20 are located generally on the same line (shown in a chain line in FIG. 10) inclined by a predetermined angle (10 to 40 degrees) to a vertical line. This is for dispersing the impact applying to the pedestrian at a collision with the pedestrian.

### Second Embodiment

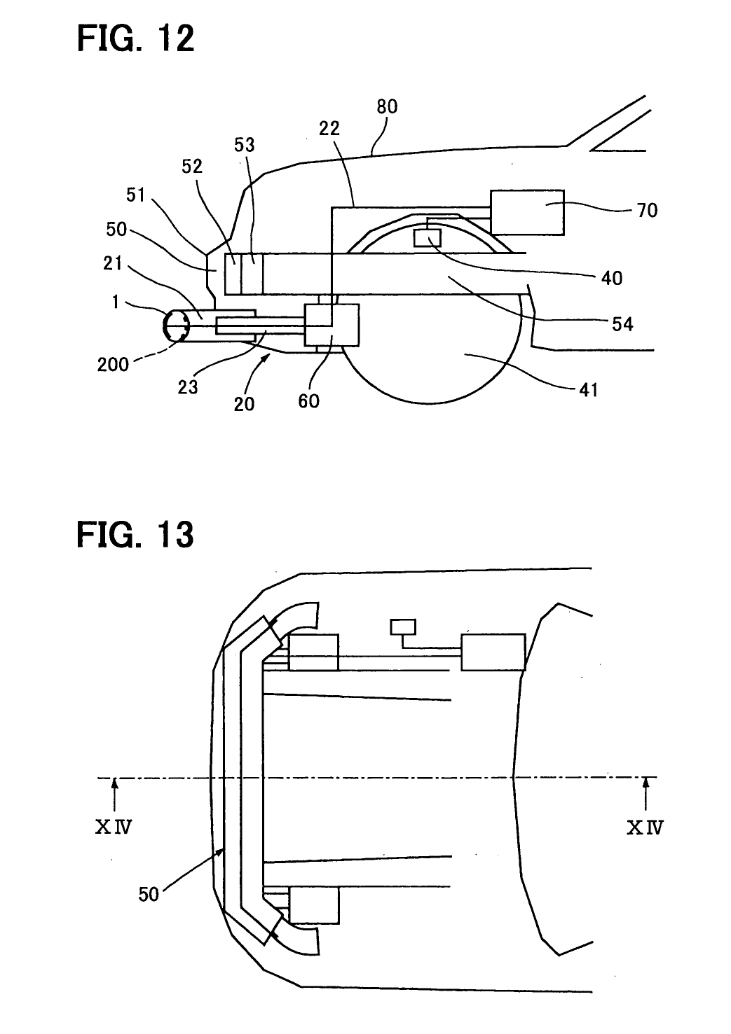

Another embodiment of the present colliding obstacle detection apparatus will be described hereinafter referring to FIGS. 11 and 12. In these Figures, the extendable pedestrian bumper 20 is extended.

On front face of the vehicle body 100 is provided front bumper 50 comprising a bumper cover 51 and a bumper absorber 52 covered with the bumper 51. The bumper absorber 52 is located in front of a bumper reinforcement 53. The bumper reinforcement 53 is fixed at the front end portion of the side members 54.

As shown in FIG. 12, below the front bumper 50 is located an extendable pedestrian bumper 20. The pedestrian bumper 20 comprises a pair of actuators 60 each of which is fixed on the side member 54, rods protruding forward from the actuators 60 and a plastic bumper plate 21 supported by the two rods and extending from side to side. Wiring 22 connects sensors 1, 200 and a control unit 70. Stays 23 support the rods slidably forward and backward and are fixed onto the vehicle body. 80 is hood of the vehicle. Control unit 70 operates the actuators 60 according to signals sent from respective sensors so that the bumper plate 21 of the pedestrian bumper 20 extends when vehicle velocity is in a predetermined range and retracts in other range of vehicle velocity. Instead of the extendable pedestrian bumper 20, a pedestrian bumper may be fixed onto the vehicle body to extend below and forward than the front bumper 50.

On each of a front and a rear faces of the bumper plate 21 are respectively installed an impedance sensors 1 shown in FIG. 4 and a colliding load sensor 300 to extend side to side thereof. The impedance sensor 1 is already described above. The collision detector 200 is further described in the following.

The sheet colliding load sensor 200 detects the resistance variety according to the stress applied thereto by the deformation of the bumper plate 21 at a collision. A conventional piezoelectric sheet material implements the colliding load sensor 200. It is reasonable that the colliding load sensor 200 may be installed on the front face of the bumper plate 200, and the pressure sensor described in the first embodiment may implement the colliding load sensor 200.

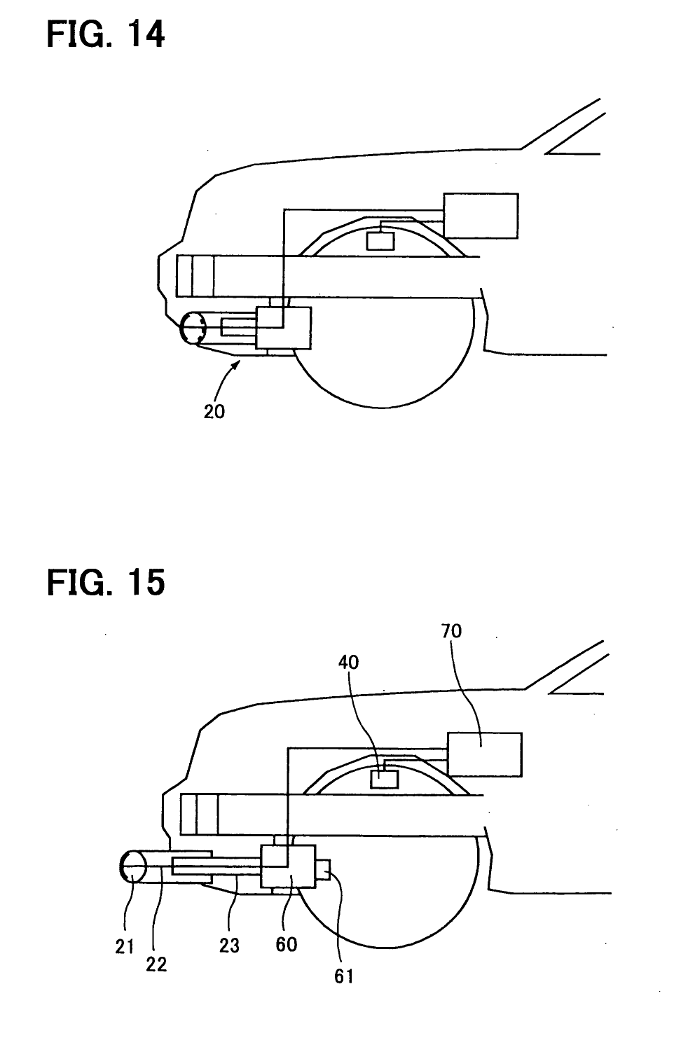

As shown in FIGS. 11 and 12, the actuator 60 extends forward the bumper plate 21 when the vehicular velocity is small. As shown in FIGS. 13 and 14, the actuator 60 extends forward the bumper plate 21 when the vehicle is in a halt or in a slow traveling. Thus, the sensitivity of respective kinds of sensors decreases during a halt or a slow traveling so that the pedestrian protector does not operate erroneously. During a fast traveling, the bumper plate 21 may be retracted because the pedestrian protector cannot the function well, however, it is further desirable to extract the bumper plate 21 to increase accuracy in detecting other vehicles or obstacles. Thus, the sensors for detecting pedestrian serve to detect collision with other vehicle at an earlier timing.

### Third Embodiment

The third embodiment is described referring to FIG. 15. In the third embodiment, an oil cylinder supplied with hydraulic pressure from a hydraulic pump system 52 implements the actuator 60. The rods above are piston rods of the cylinders. The hydraulic cylinder 60 has a pressure sensor 61 detecting the pressure in the hydraulic chamber in the hydraulic cylinder 60. The hydraulic cylinders 60 protrude and retract the rods. When a pedestrian collides with the bumper plate21, the rods retract suddenly by the collision impact and the oil pressure in the oil cylinder 60 suddenly increases temporary. It is possible to detect the colliding load by detecting the oil pressure by the oil pressure sensor 61.

### Fourth Embodiment

In the first embodiment, the number of the impedance sensor 1 and/or that of the piezoelectric sheet sensor 30 may be plural to be arranged on the front face of the bumper plate 21 of the pedestrian bumper 20. The drawing thereof is not shown in the Figs. The same types of sensors align in a side-to-side direction on the bumper plate 21 and output signals detected respectively. Thus, it becomes possible to detect the colliding position in the side-to-side direction.

### Fifth Embodiment

In each of the above embodiments, each of the sensors is located on the bumper plate 21 of the pedestrian bumper 20 or detects the status change of the bumper plate 21 at a collision. Instead, it is possible to locate on the bumper plate 21 or to use for detecting the status change thereof at least one kind of the sensors, and to locate on another portion such as front bumper at least one kind of the sensors.

### Sixth Embodiment

In this embodiment, as shown in FIG. 12, the front end of the extensible pedestrian bumper 20 comes ahead on a generally straight line which the front ends of the front bumper 50 and of the hood are on in each of the above embodiments. Thus, the legs of a pedestrian colliding with the vehicle touches the straight line composed of the bumper plate 21, front bumper 50 and hood 80 (refer to FIG. 12), so as to prevent the legs, especially at knees hard to bend, of the pedestrian from receiving large bending force and to reduce the injury of the pedestrian.

This description of the invention is merely exemplary in nature and, thus, variations that do not depart from the gist of the invention are intended to be within the scope of the invention. Such variations are not to be regarded as a departure from the spirit and scope of the invention.

1. A colliding obstacle detection apparatus for a vehicle comprising:
a pedestrian bumper supported below a front bumper of the vehicle by a body of the vehicle, a front end of the pedestrian bumper vertically aligning with or extending ahead of that of the front bumper;
at least one collision detector located on the pedestrian bumper and detecting one of:
a collision of the pedestrian bumper with an obstacle; and
a presence of the obstacle in a close proximity to the pedestrian bumper; and
a control circuit determining whether the collision has actually occurred based on a detection signal outputted by the at least one collision detector and activating a colliding obstacle protector located on the vehicle when it is determined that the collision has actually occurred.

2. The colliding obstacle detection apparatus according to claim 1, wherein:
the pedestrian bumper is extendable in a fore-and-aft direction of the vehicle; and
the pedestrian bumper extends ahead of the front bumper when the vehicle is traveling in a predetermined range of velocity and retracts behind of the front bumper when the vehicle is in a halt.

3. The colliding obstacle detection apparatus according to claim 1, wherein the pedestrian bumper is secured to the body of the vehicle.

4. The colliding obstacle detection apparatus according to claim 1, wherein the obstacle is a pedestrian.

5. The colliding obstacle detection apparatus according to claim 1, wherein:
the at least one collision detector includes an impedance sensor, which detects the one of the collision with the obstacle and the presence of the obstacle based on a change in an AC impedance thereof caused by the one of the collision with the obstacle and the presence of the obstacle.

6. The colliding obstacle detection apparatus according to claim 5, wherein:
the impedance sensor includes a coil; and
the AC impedance includes a coil impedance of the coil.

7. The colliding obstacle detection apparatus according to claim 5, wherein:
the impedance sensor includes an electrode of a grounded capacitor; and
the AC impedance includes a grounded capacitance of the grounded capacitor.

8. The colliding obstacle detection apparatus according to claim 5, wherein:
the impedance sensor includes a coil and an electrode of a grounded capacitor;
the AC impedance correlates with both a coil impedance of the coil and a grounded capacitance of the grounded capacitor; and
the control circuit identifies a type of the obstacle based on the AC impedance.

9. The colliding obstacle detection apparatus according to claim 8, wherein:
one end of the coil is supplied with electricity from an AC power source, which has two terminals, wherein one of the two terminals is connected to the one end of the coil, and the other one of the two terminals is grounded, the other end of the coil is connected to the electrode of the grounded capacitor;
the obstacle is one of a metallic body and a pedestrian;
the collision detector detects the one of the collision with the metallic obstacle and the presence of the metallic obstacle when a potential of the electrode increases; and
the collision detector detects the one of the collision with the pedestrian and the presence of the pedestrian when the potential of the electrode decreases.

10. The colliding obstacle detection apparatus according to claim 1, wherein the at least one collision detector includes a colliding load sensor detecting a colliding load acting on the pedestrian bumper.

11. The colliding obstacle detection apparatus according to claim 1, wherein:
the pedestrian bumper is moved by an actuator in a fore-and-aft direction of the vehicle; and
the colliding load sensor detects a physical quantity of the actuator, which indicates an operational state of the actuator.

12. The colliding obstacle detection apparatus according to claim 11, wherein:
the actuator includes a hydraulic cylinder; and
the physical quantity includes an oil pressure of the hydraulic cylinder.

13. The colliding obstacle detection apparatus according to claim 1, wherein the at least one collision detector includes an ultrasonic sensor located on the pedestrian bumper.

14. The colliding obstacle detection apparatus according to claim 1, wherein:
the at least one collision detector includes an impedance sensor and one of a colliding load sensor and a ultrasonic sensor; and
the control circuit operates based on:
the detection signal outputted by the impedance sensor; and
the detection signal outputted by the one of the colliding load sensor and the ultrasonic sensor.

15. The colliding obstacle detection apparatus according to claim 1, wherein the at least one collision detector includes a plurality of the collision detectors arranged one after another in a side-to-side direction on the pedestrian bumper.

16. The colliding obstacle detection apparatus according to claim 15, wherein the control circuit detects a position of the obstacle in the side-to-side direction on the pedestrian bumper.

17. The colliding obstacle detection apparatus according to claim 1, wherein a front end of the pedestrian bumper, which is located in its foremost position, is located on an extension of an imaginary line that connects between a front end of the front bumper and a front end of a hood of the vehicle.
